(19) United States
(12) Patent Application Publication
(10) Pub. No.: US 2018/0349179 A1
(43) Pub. Date: Dec. 6, 2018

(54) CENTRALIZED FLEXIBLE DEPLOYMENT SYSTEM

(71) Applicant: LinkedIn Corporation, Sunnyvale, CA (US)

(72) Inventors: Timothy D. Worboys, Sunnyvale, CA (US); Sergei V. Titov, Mountain View, CA (US); John Rabedeau, Redwood City, CA (US); James D. Langille, Sunnyvale, CA (US); Menglin L. Brown, Redwood City, CA (US); Joyce Victoria Wang, Mountain View, CA (US); Jinzheng Sha, Sunnyvale, CA (US); Sergey Leshchenko, San Francisco, CA (US); Shane M. Watson, Fremont, CA (US)

(73) Assignee: LinkedIn Corporation, Sunnyvale, CA (US)

(21) Appl. No.: 15/609,265

(22) Filed: May 31, 2017

(51) Int. Cl. G06F 9/48; G06F 9/50; G06F 9/445

(52) U.S. Cl. CPC G06F 9/4881; G06F 8/60; G06F 9/5005

(57) ABSTRACT

The disclosed embodiments provide a system for managing deployment of a software product. During operation, the system obtains a current state and a set of steps in a deployment workflow for the product. Upon receiving a request to deploy the product in a next step following the current state in the deployment workflow, the system identifies a deployment window containing a start time and an end time in a deployment schedule for the product. When the deployment window is open, the system uses the deployment workflow to automatically initiate deployment of the product to an environment representing the next step.

### BACKGROUND

### Field

The disclosed embodiments relate to software deployment in data centers. More specifically, the disclosed embodiments relate to a centralized flexible system for deploying products such as applications and services to data centers.

### Related Art

Data centers and cloud computing systems are commonly used to run applications, provide services, and/or store data for organizations or users. Within the cloud computing systems, software providers may deploy, execute, and manage applications and services using shared infrastructure resources such as servers, networking equipment, virtualization software, environmental controls, power, and/or data center space. Some or all resources may also be dynamically allocated and/or scaled to enable consumption of the resources as services. Consequently, management and use of data centers may be facilitated by mechanisms for efficiently managing the deployment of applications and services on data center resources.

### BRIEF DESCRIPTION OF THE FIGURES

FIG. 1 shows a schematic of a system in accordance with the disclosed embodiments.

FIG. 2 shows a system for managing deployment of products in accordance with the disclosed embodiments.

FIG. 3 shows a flowchart illustrating a process of managing deployment of a product in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

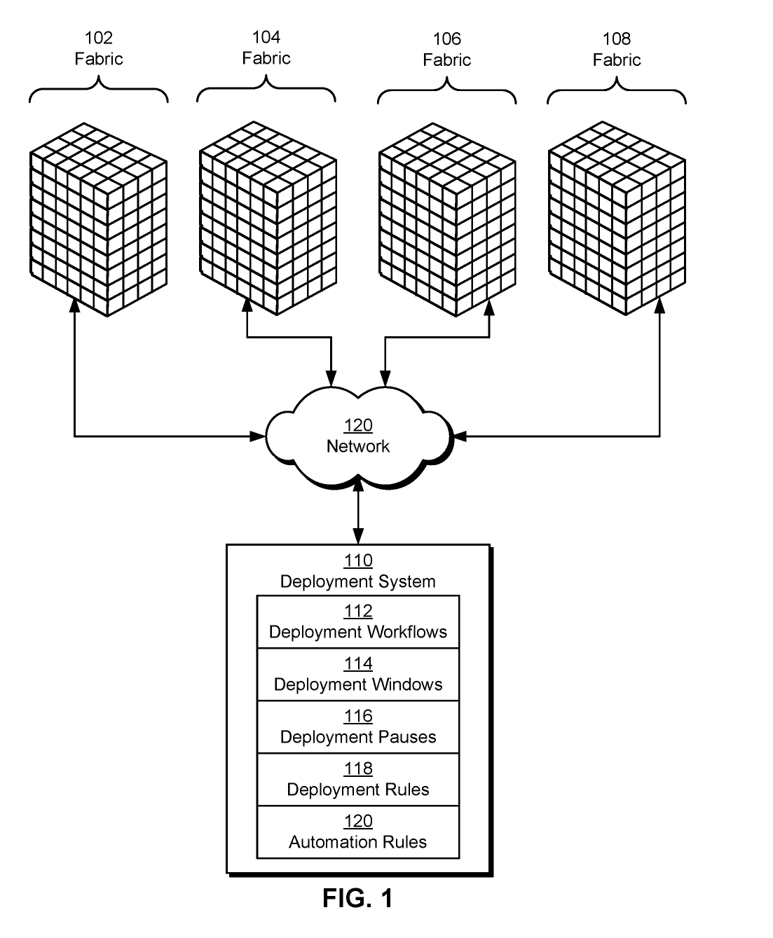

The disclosed embodiments provide a method, apparatus, and system for managing the deployment of products to data center fabrics. As shown in FIG. 1, the products may be deployed across a set of fabrics 102-108 in data centers, collocation centers, cloud computing systems, clusters, content delivery networks, and/or other collections of processing, storage, network, and/or other resources. Resources in and across fabrics 102-108 may be connected to one another over a network 120 such as a local area network (LAN), wide area network (WAN), personal area network (PAN), virtual private network, intranet, mobile phone network (e.g., a cellular network), WiFi network, Bluetooth network, universal serial bus (USB) network, Ethernet network, and/or switch fabric.

A deployment system 110 may manage deployment of the products to fabrics 102-108. For example, deployment system 110 may be used to perform centralized, flexible deployment of applications, services, websites, and/or features in an online professional network to fabrics 102-108. First, deployment system 110 may manage deployment workflows 112 for the products. Each deployment workflow may include a series of steps taken during the deployment of the corresponding product. For example, a deployment workflow may include steps related to deployment of the product to development, integration, testing, staging, production, and/or other environments. Steps in the deployment workflow may be arranged in one or more linear and/or branched paths.

Second, deployment system 110 may use deployment windows 114 and deployment pauses 116 to schedule product deployments. Each product may have a deployment schedule that includes a deployment window with a start time and an end time. As a result, deployment system 110 may delay deployment of the product until the deployment window is open. Deployment pauses 116 may also be created for products that match certain attributes. When a deployment pause is in effect for a certain product, deployment of the product may be delayed until the period spanned by the deployment pause has lapsed.

Third, deployment system 110 may apply a set of deployment rules 118 to the deployments. Deployment rules 118 may specify constraints associated with deployment of the products, such as requirements related to the prioritizing of deployments, discarding of deployments, requesting of deployments, and/or completion of previous steps in deployment workflows 112 before proceeding to subsequent steps. Similarly, deployment system 110 may use a set of automation rules 120 to automate deployment of the products at various steps in their respective deployment workflows 112 when events that represent triggers in automation rules 120 are received. As a result, deployment system 110 may be used to perform centralized, automatic, flexible, policy-based deployment of products to fabrics 102-108, as described in further detail below.

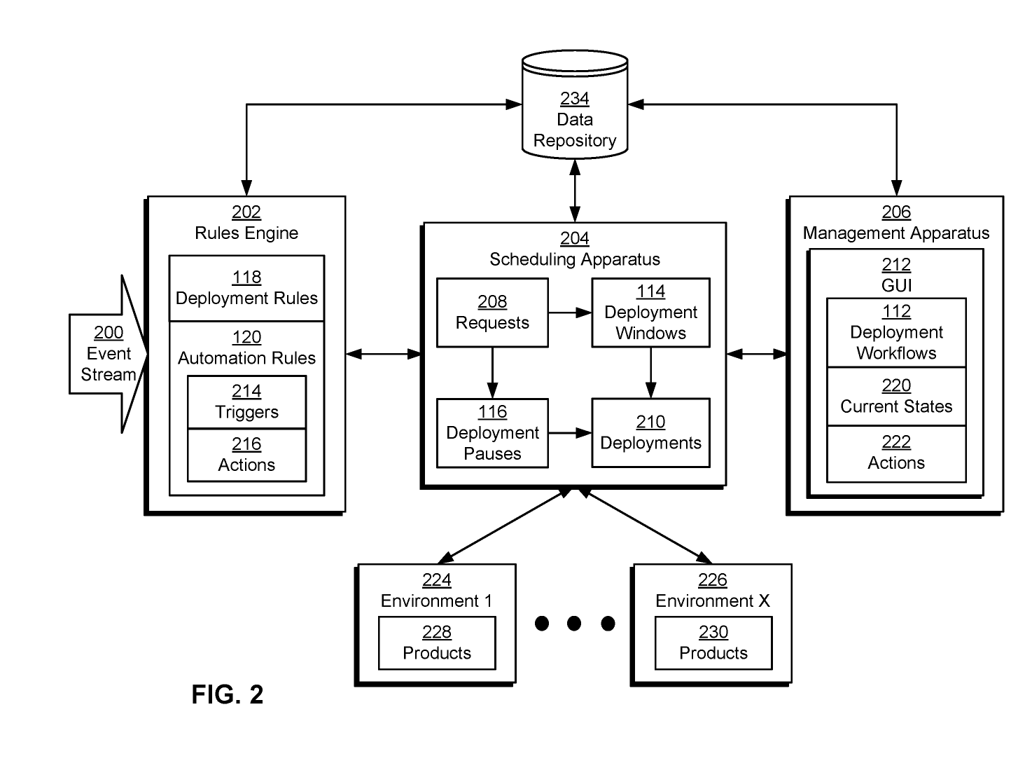

FIG. 2 shows a system for managing deployments 210 of products 228-230, such as deployment system 110 of FIG. 1, in accordance with the disclosed embodiments. The system includes a rules engine 202, a scheduling apparatus 204, and a management apparatus 206. Each of these components is described in further detail below.

As mentioned above, the system of FIG. 2 may be used to schedule, prioritize, pause, trigger, and/or otherwise manage deployments 210 of products 228-230 to multiple environments (e.g., environment 1 224, environment x 226). Each environment may represent a different stage or step in the deployment workflow (e.g., deployment workflows 112) of a product. For example, environments to which products 228-230 are deployed may include development, integration, testing, staging, canary, and/or production environments. The environments may be located in the same or different data centers, collocation centers, cloud computing systems, clusters, content delivery networks, content distribution platforms, and/or other collections of resources.

Scheduling apparatus 204 may initiate deployments 210 based on requests 208 from other components of the system to deploy products 228-230. Requests 208 may be received and/or generated from a number of sources. First, a task scheduler may be used to schedule a request to occur at a pre-specified time (e.g., a number of hours or days later and/or a specific time and day). When the pre-specified time is reached, the task scheduler may transmit the request to scheduling apparatus 204 for processing by scheduling apparatus 204. The task scheduler and/or another component of the system may also be used to schedule recurring deployments of a product. For example, the component may schedule requests for deploying the latest version of a mobile application to a digital distribution platform (e.g., an app store) several times a day on a daily basis.

Second, a subset of requests 208 may be generated through a graphical user interface (GUI) 212 provided by management apparatus 206. As shown in FIG. 2, management apparatus 206 may obtain deployment workflows 112 and/or current states 220 of products 228-230 from data repository 234 and/or another data store.

Each deployment workflow may be a set of deployment steps connected by one or more paths. For example, deployment workflows 112 may be specified in database records, property lists, Extensible Markup language (XML) documents, JavaScript Object Notation (JSON) objects, and/or other types of structured data. A deployment workflow may specify, in each path, a series of environments in which the corresponding product is to be deployed until the product reaches deployment in a production environment. The deployment workflow may also contain multiple branched paths, including branches related to automated deployment, user-driven deployment, pre-scheduled deployment, and/or other types of deployment for the product.

As each product is published, committed, successfully deployed, unsuccessfully deployed, rolled back, and/or otherwise modified in one or more environments, the corresponding deployment workflow and/or other records tracking the current state of the product may be updated to reflect the modification. As a result, the current state of the product may include the product's progress through the deployment workflow, as well as the product's state of deployment (e.g., nominated for deployment, deployed, failed to deploy, previously deployed, rolled back, not yet deployed, etc.) in various steps of the deployment workflow.

Separate deployment workflows 112 and current states 220 may be maintained for different products, as well as different versions of a product. As a result, management apparatus 206 and/or another component of the system may match the product name and product version of each product to a different deployment workflow and/or current state in data repository 234. Management apparatus 206 may then display the deployment workflow and current state within GUI 212 (e.g., in response to a search for or selection of the product name and/or version within GUI 212). For example, management apparatus 206 may display, as part of the current state of a product, a series of commits made to the product and the deployment workflow steps (e.g., environments) to which the commits were made. Management apparatus 206 may also, or instead, display a grid with a first axis representing a set of numeric versions of the product and a second axis representing steps in the deployment workflow for the product. Each cell in the grid may specify a state of deployment for the corresponding numeric version from the first axis and the corresponding step in the deployment workflow from the second axis. In other words, the grid may provide a centralized “view” of multiple versions of the product, as well as the state of deployment of each version in each step of the product's deployment workflow.

Management apparatus 206 may also receive actions 222 related to deployment workflows 112 and current states 220 through GUI 212. For example, management apparatus 206 may allow users to graphically construct and modify deployment workflows 112 within GUI 212. In another example, management apparatus 206 may receive actions 222 for creating, modifying, deleting, and/or cancelling requests 208, deployment windows 114, deployment pauses 116, and/or deployments 210. In turn, management apparatus 206 may store representations of actions 222 in data repository 234 and/or another data store and provide actions 222 representing requests 208 to deploy one or more products 228-230 to scheduling apparatus 204 for further processing of requests 208 by scheduling apparatus 204.

Third, a subset of requests 208 may automatically be generated by rules engine 202 based on automation rules 120 that include triggers 214 and actions 216. More specifically, automation rules 120 may specify triggers 214 representing criteria to be met by current states 220, actions 222, and/or other events related to deployment workflows 112. For example, automation rules 120 may identify one or more of the following as triggers 214: publishing of a build, a successful test result, a successful deployment to a previous step in the deployment workflow, and/or a healthy canary environment.

Automation rules 120 may also specify actions 216 that are taken in response to the corresponding triggers 214. For example, automation rules 120 may include an action of automatically generating a request to deploy a product to the next step in the corresponding deployment workflow after a trigger representing successful deployment, testing, canary testing, and/or publishing of the product to the same step or a previous step in the deployment workflow is received. In another example, automation rules 120 may specify actions 216 for automatically rolling back a product to a previous version in a given step of the deployment workflow when triggers 214 such as a bug or issue in the current version of the product occur.

Rules engine 202 may also obtain a number of events related to automation rules 120 from an event stream 200. Each event may represent a record of activity collected from a monitored system, such as an environment in which a product can be deployed. The record may be provided by a server, data center, and/or other component in the environment and aggregated to event stream 200 for further processing by rules engine 202. In turn, rules engine 202 may process the records by subscribing to different types of events in the event stream and matching the records to triggers 214 and/or other parameters in automation rules 120.

Products 228-230 may include components of a social network or other community of users, such as an online professional network. The online professional network may allow users to establish and maintain professional connections; list work and community experience; endorse, follow, message, and/or recommend one another; search and apply for jobs; and/or engage in other professional or social networking activity. Employers may list jobs, search for potential candidates, and/or provide business-related updates to users.

The online professional network may also display a content feed containing information that may be pertinent to users of the online professional network. For example, the content feed may be displayed within a website and/or mobile application for accessing the online professional network. Feed updates in the content feed may include posts, articles, scheduled events, impressions, clicks, likes, dislikes, shares, comments, mentions, views, updates, trending updates, conversions, and/or other activity or content by or about various entities (e.g., users, companies, schools, groups, skills, tags, categories, locations, regions, etc.). The feed updates may also include content items associated with the activities, such as user profiles, job postings, user posts, status updates, messages, sponsored content, event descriptions, articles, images, audio, video, documents, and/or other types of content from the content repository. As a result, events in event stream 200 may enable tracking and/or monitoring of activity related to deployment workflows 112 of services, repositories, clients, servers, web applications, mobile applications, frontends, middle tiers, backends, and/or other components for generating job and/or connection recommendations, the content feed, user-interface elements, pages, and/or other features of the online professional network.

When an event from event stream 200 matches a trigger in automation rules 120, rules engine 202 may automatically carry out the corresponding action. For example, rules engine 202 may match an event indicating successful testing of a product in a testing environment to a trigger in an automation rule with an action that automatically advances the product to a canary environment in the deployment workflow. In turn, rules engine 202 may transmit, to scheduling apparatus 204, a request to deploy the product to the canary environment. When an additional event indicating passing of a canary health check by the product in the canary environment is received in event stream 200, rules engine 202 may match the additional event to a trigger in another automation rule with an action that automatically advances the product to a production environment in the deployment workflow. As a result, rules engine 202 may transmit, to scheduling apparatus 204, an additional request to deploy the product to the production environment. In other words, rules engine 202 may include functionality to automate some or all of the deployment workflow for one or more products 228-230 by matching events in event stream 200 to triggers 214 in automation rules 120 and carrying out the corresponding actions 216 when triggers 214 are satisfied.

After a request to deploy a product to a given environment is received, scheduling apparatus 204 may process the request based on a number of factors. First, scheduling apparatus 204 may obtain a deployment schedule containing one or more deployment windows 114 for the corresponding product. For example, scheduling apparatus 204 may match the product name, product version, and/or environment (e.g., fabric name) in the request to a deployment configuration and/or other record containing the deployment schedule. The deployment configuration and/or record may be stored in data repository 234 and/or another data store.

The deployment schedule may specify a start time and an end time for each deployment window. For example, the deployment schedule may include a weekly schedule that identifies the hours of 5 to 10 pm in a given time zone on Mondays and Wednesdays as deployment windows for the product. The deployment schedule may additionally be specified by a team that builds or supports the product to accommodate the team's work schedule. For example, the deployment schedule may include deployment windows that align with normal work hours and/or on-call periods for the team. If the request is received while a deployment window for the product is open, scheduling apparatus 204 may initiate deployment of the product to the environment specified in the request. If the request is received while the deployment window is closed, the request may be delayed until the deployment window is opened or reopened.

Second, scheduling apparatus 204 may manage deployment of the product based on deployment pauses 116 related to the product. Unlike deployment windows 114, deployment pauses 116 may specify periods of time in which deployments 210 of matching products are delayed or stopped. Each deployment pause may specify a start time, end time, and one or more attributes of products 228-230 to which the deployment pause applies. For example, the deployment pause may specify a product name, product version, fabric, time of deployment, a timeframe (i.e., start and end times), and/or an origin of the request (e.g., user input through GUI 212, an automation rule in rules engine 202, a scheduled request from a task scheduler, a command-line interface (CLI), etc.). The deployment pause may also indicate a reason for the pause and/or a ticket associated with the pause. In turn, the deployment pause may be created to prevent deployments 210 during planned blackout periods, problems with specific products or environments, and/or certain product deployments during deployments or launches of other products.

If a deployment pause is in effect for the request, deployment of the corresponding product may be paused or delayed until the deployment pause no longer applies to the request. If no deployment pauses apply to the request and the deployment window for the product is open, scheduling apparatus 204 may initiate deployment of the product to the environment specified in the request.

Third, scheduling apparatus 204, rules engine 202, and/or another component of the system may apply deployment rules 118 to requests 208 and/or deployments 210. Deployment rules 118 may specify a configurable policy related to carrying out actions (e.g., actions 216 and 222) related to deployment workflows 112. For example, deployment rules 118 may be stored in one or more files, records, and/or data structures in data repository 234. In turn, components of the system may access data repository 234 to create, access, modify, and/or delete deployment rules 118.

Deployment rules 118 may relate to prioritizing deployments 210, carrying out or omitting requests 208, and/or otherwise handling deployments 210 or requests 208 independently of and/or in conjunction with deployment windows 114 and deployment pauses 116. For example, deployment rules 118 may specify that a deployment of a product to a given step in the corresponding workflow can be carried out only when previous steps in the deployment workflow have successfully completed. In another example, deployment rules 118 may prioritize rollback of a product over deployment of another product in the same environment and/or any pauses or deployment windows related to the products (e.g. because the rollback may result from a bug or other problem in the newest version of the product). In a third example, deployment rules 118 may specify omitting deployment of an older version of a product and/or rejecting requests to deploy the older version to a given environment if a newer version of the product has been deployed in the environment or deployment of the newer version in the environment has been initiated. In a fourth example, deployment rules 118 may restrict a request to deploy a product to an administrator, operator, owner, and/or delegate of the product. In a fifth example, deployment rules 118 may restrict deployment of a product to a single machine in a canary environment and subsequently passing a canary health check on the machine before the product is deployed to additional machines in the same environment or a different environment.

After scheduling apparatus 204 determines that a given request conforms to deployment windows 114, deployment pauses 116, and deployment rules 118, scheduling apparatus 204 may initiate deployment of the corresponding product by forwarding the request to a deployment processor for the corresponding environment. For example, scheduling apparatus 204 may use a set of application-programming interfaces (APIs) to communicate with a number of heterogeneous deployment processors that conform to a set of requirements associated with the deployment system. In other words, the system of FIG. 2 may be used to manage deployments for various environments, products, teams, and/or tenants.

If the deployment processor is currently unable to handle the request, scheduling apparatus 204 may repeat the request until the deployment processor is able to carry out the deployment. After the deployment is carried out, the deployment processor may respond to the request with a deployment result of success or failure. If the deployment is successful, scheduling apparatus 204 and/or another component of the system may report the success, update the current state of the product with the successful deployment, and optionally use the successful deployment and one or more automation rules 120 to automatically generate additional actions 216 related to the product. If the deployment is not successful, the component may report the failure (e.g., through an email, SMS, and/or other message), update the current state of the product with the failed deployment, and await user input for remedying the failure. Consequently, the system of FIG. 2 may perform centralized, flexible, automated, and policy-based deployment of products 228-230 within deployment workflows 112.

Those skilled in the art will appreciate that the system of FIG. 2 may be implemented in a variety of ways. More specifically, rules engine 202, scheduling apparatus 204, management apparatus 206, data repository 234 and one or more deployment processors may be provided by a single physical machine, multiple computer systems, one or more virtual machines, a grid, one or more databases, one or more filesystems, and/or a cloud computing system. Rules engine 202, scheduling apparatus 204, management apparatus 206 and one or more deployment processors may additionally be implemented together and/or separately by one or more hardware and/or software components and/or layers.

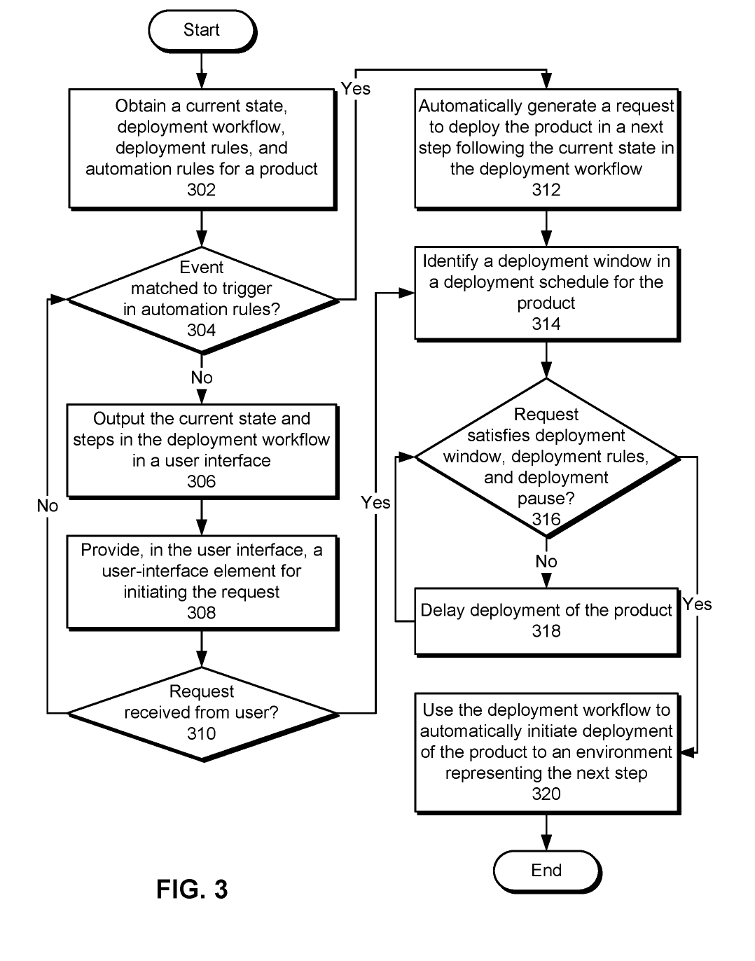

FIG. 3 shows a flowchart illustrating a process of managing deployment of a product in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a current state, deployment workflow, deployment rules, and automation rules for a product are obtained (operation 302). The deployment workflow may include a set of steps arranged in a single linear path and/or a set of branched paths. Each step may include an environment used in deployment of the product. For example, the deployment workflow may specify deployment of the product in one or more development, integration, testing, staging, canary, and/or production environments.

The current state of the product may include a deployment status (e.g., successful, failed, not yet deployed, rolled back, etc.) of the product at each step of the deployment workflow and/or a set of commits of the product to one or more environments in the deployment workflow. The deployment rules may specify a general policy for carrying out deployments in deployment workflows based on product versions, deployment orders in the deployment workflows, ownership of the products, and/or other parameters related to the products or deployment workflows. The automation rules may include triggers related to the deployment workflows and actions that are carried out in response to the triggers.

An event may be matched to a trigger in the automation rules (operation 304). For example, the event may be received in an event stream related to deployment of products in one or more environments. The trigger may include, for a given product and/or product version, publishing of a build, a test result, a canary result, and/or a successful or failed deployment. If the event matches the trigger (thereby indicating the trigger has occurred), a request to deploy the product in a next step following the current state in the deployment workflow is automatically generated (operation 312). Thus, automatic generation of the request may correspond to an action to which the trigger is linked in the automation rules. Conversely, the event may match a trigger indicating a failed deployment and/or other issue with the product. In turn, a request to rollback the product and/or otherwise remedy the issue may be generated in response to the event.

If no request has been generated based on one or more triggers in the automation rules, a request to deploy the product may be obtained from a user. In particular, the current state and steps in the deployment workflow are outputted in a user interface (operation 306), and a user-interface element for initiating the request is provided in the user interface (operation 308) to enable receipt of the request from a user (operation 310) through the user interface. For example, the user interface may include a GUI, CLI, and/or other type of interface for interacting with the user. The user interface may provide textual and/or graphical representations of the current state and deployment workflow. The user interface may also provide form fields, drop-down menus, commands, and/or other types of user-interface elements for specifying requests to deploy specific products to specific environments. Operations 304-310 may be repeated until a request is received from a user through the user interface or automatically generated after an event matches a trigger in the automation rules. Requests may also be received through other mechanisms, such as APIs with other systems.

After a request is received through the user interface, from an API with another system, and/or automatically generated in response to a trigger in the automation rules, a deployment window in a deployment schedule for the product is identified (operation 314). The deployment window may include a start time and an end time in the deployment schedule. The deployment window may occur once or on a repeating (e.g., daily, weekly, biweekly, monthly, etc.) basis.

The request is then processed based on the request satisfying the deployment window, deployment rules, and a deployment pause (operation 316). For example, the request may be eligible for fulfillment if the request is received while the deployment window is open, if the request does not violate any of the deployment rules, and the request does not match one or more attributes of a deployment pause (e.g., product name, product version, fabric, deployment pause timeframe, time of request, origin of request). If the deployment window is closed, the deployment rules are not satisfied, and/or a deployment pause applies to the request, deployment of the product is delayed (operation 318).

Once the request satisfies constraints related to the deployment window, deployment rules, and deployment pause, the deployment workflow is used to automatically initiate deployment of the product to an environment representing the next step (operation 320) in the deployment workflow. For example, the current state of the product, the environment to which the product is to be deployed, and/or parameters for deploying the product to the environment may be obtained from the deployment workflow, and the request may be forwarded with the parameters to a deployment processor for the environment.

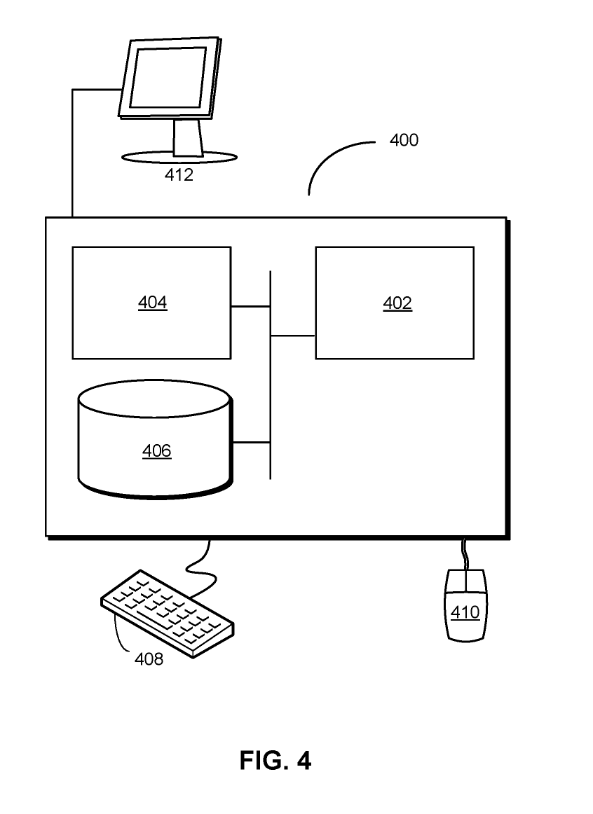

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for managing deployment of a software product. The system may include a scheduling apparatus and a rules engine, one or both of which may alternatively be termed or implemented as a module, mechanism, or other type of system component. The scheduling apparatus may obtain a current state and a set of steps in a deployment workflow for the product. Upon receiving a request to deploy the product in a next step following the current state in the deployment workflow, the scheduling apparatus may identify a deployment window containing a start time and an end time in a deployment schedule for the product. When the deployment window is open, the scheduling apparatus may use the deployment workflow to automatically initiate deployment of the product to an environment representing the next step.

The rules engine may obtain a set of deployment rules and a set of automation rules for the workflow. Next, the rules engine may apply the deployment rules to the deployment of the product and other products to environments in the products' deployment workflows. When an event is matched to a trigger in the automation rules for deploying the product in the next step, the rules engine may automatically generate the request without receiving the request from a user.

In addition, one or more components of computer system 400 may be remotely located and connected to the other components over a network. Portions of the present embodiments (e.g., rules engine, scheduling apparatus, management apparatus, data repository, environments, etc.) may also be located on different nodes of a distributed system that implements the embodiments. For example, the present embodiments may be implemented using a cloud computing system that manages and automates the deployment of a set of products to a set of remote environments.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a current state and a set of steps in a deployment workflow for a first product; and
upon receiving a first request to deploy the first product in a next step following the current state in the deployment workflow, processing the request by one or more computer systems by:
identifying a deployment window comprising a start time and an end time in a deployment schedule for the first product; and
when the deployment window is open, using the deployment workflow to automatically initiate deployment of the first product to an environment representing the next step.

2. The method of claim 1, further comprising:
when the first request is matched to one or more attributes of a deployment pause, pausing deployment of the first product until the deployment pause does not apply to the first request.

3. The method of claim 2, wherein the one or more attributes comprise at least one of:
a product name;
a product version;
a fabric;
a time of the request; and
an origin of the first request.

4. The method of claim 1, further comprising:
obtaining a set of deployment rules; and
applying the deployment rules to the deployment of the first product to the environment and to deployment of a second product to an additional environment.

5. The method of claim 4, wherein applying the deployment rules comprises at least one of:
prioritizing rollback of the second product over deployment of the first product; and
omitting deployment of an older version of the first product after the first request is received.

6. The method of claim 4, wherein the set of deployment rules is associated with at least one of:
a product version;
a deployment order in the deployment workflow; and
an ownership of the first product.

7. The method of claim 1, further comprising:
obtaining a set of automation rules for the deployment workflow; and
when an event is matched to a trigger in the automation rules for deploying the first product in the next step, automatically generating the first request without receiving the first request from a user.

8. The method of claim 7, wherein the trigger is at least one of:
publishing of a build;
a test result;
a canary result; and
a deployment.

9. The method of claim 1, further comprising:
outputting the current state and the set of steps in a user interface; and
providing, in the user interface, a user-interface element for initiating the first request.

10. The method of claim 1, wherein obtaining the current state and the set of steps in the deployment workflow for the first product comprises:
obtaining a product name and a product version for the first product; and
obtaining the current state and the set of steps in the deployment workflow in a deployment configuration for the product name and the product version.

11. The method of claim 1, wherein the set of steps is arranged in a set of branched paths in the deployment workflow.

12. The method of claim 1, wherein the environment at least one of:
a development environment;
an integration environment;
a testing environment;
a staging environment;
a canary environment; and
a production environment.

13. An apparatus, comprising:
one or more processors; and
memory storing instructions that, when executed by the one or more processors, cause the apparatus to:
obtain a current state and a set of steps in a deployment workflow for a first product;
upon receiving a first request to deploy the first product in a next step following the current state in the deployment workflow, identify a deployment window comprising a start time and an end time in a deployment schedule for the first product; and
when the deployment window is open, use the deployment workflow to automatically initiate deployment of the first product to an environment representing the next step.

14. The apparatus of claim 13, wherein the memory further stores instructions that, when executed by the one or more processors, cause the apparatus to:
when the first request is matched to one or more attributes of a deployment pause, pause deployment of the first product until the deployment pause does not apply to the first request.

15. The apparatus of claim 13, wherein the memory further stores instructions that, when executed by the one or more processors, cause the apparatus to:
obtain a set of deployment rules; and
apply the deployment rules to the deployment of the first product to the environment and to deployment of a second product to an additional environment.

16. The apparatus of claim 15, wherein applying the deployment rules comprises at least one of:
prioritizing rollback of the second product over deployment of the first product; and
omitting deployment of an older version of the first product after the first request is received.

17. The apparatus of claim 13, wherein the memory further stores instructions that, when executed by the one or more processors, cause the apparatus to:
obtain a set of automation rules for the deployment workflow; and
when an event is matched to a trigger in the automation rules for deploying the first product in the next step, automatically generate the first request without receiving the first request from a user.

18. The apparatus of claim 17, wherein the trigger is at least one of:
publishing of a build;
a test result;
a canary result; and
a deployment.

19. A system, comprising:
a scheduling module comprising a non-transitory computer-readable medium comprising instructions that, when executed, cause the system to:
obtain a current state and a set of steps in a deployment workflow for a first product;
upon receiving a first request to deploy the first product in a next step following the current state in the deployment workflow, identify a deployment window comprising a start time and an end time in a deployment schedule for the first product; and
when the deployment window is open, use the deployment workflow to automatically initiate deployment of the first product to an environment representing the next step; and
a rules engine comprising a non-transitory computer-readable medium comprising instructions that, when executed, cause the system to:
obtain a set of automation rules for the deployment workflow; and
when an event is matched to a trigger in the automation rules for deploying the first product in the next step, automatically generate the first request without receiving the first request from a user.

20. The system of claim 19, wherein the trigger is at least one of:
publishing of a build;
a test result;
a canary result; and
a deployment.
